(19) United States
(12) Patent Application Publication
(10) Pub. No.: US 2019/0138199 A1
(43) Pub. Date: May 9, 2019

(54) SYSTEM AND METHOD OF FINGER SWIPE GESTURE DETECTION BY DISPLAY EDGE BUTTON

(71) Applicant: Aerco International, Inc., Blauvelt, NY (US)

(72) Inventor: Joseph Pagliaccio, Bayville, NY (US)

(21) Appl. No.: 16/182,779

(22) Filed: Nov. 7, 2018

Related U.S. Application Data
(60) Provisional application No. 62/582,572, filed on Nov. 7, 2017.

(51) Int. Cl. G06F 3/0488

(52) U.S. Cl. CPC G06F 3/04883; G06F 3/04817

(57) ABSTRACT

A touch sensitive display screen system for performing a touch screen finger swipe operation includes a touch sensitive display having a screen edge along an outer screen perimeter. A processor is communicatively coupled to the touch sensitive display and operatively coupled to a memory. The processor runs a trigger on release button process stored on the memory. The touch sensitive display displays at least one trigger on release button defined by a button area disposed at about an edge of the touch sensitive display as an edge button. A finger swipe motion from a position on the touch sensitive display outside of the button area, to the edge button and continuing over the screen edge, causes an action to be performed by the processor based on an indication of a screen swipe event. A method and a non-transitory computer-readable medium for processing a swipe gesture are also described.

### CROSS-REFERENCE TO RELATED APPLICATIONS

This application claims priority to and the benefit of co-pending U.S. provisional patent application Ser. No. 62/582,572, TOUCHSCREEN EDGE BUTTONS PROVIDE A SWIPE EFFECT WITH MINIMAL CONTROLLER RESOURCES, filed Nov. 7, 2017, which application is incorporated herein by reference in its entirety.

### FIELD OF THE APPLICATION

The application relates to a touch sensitive display screen, particularly to a touch sensitive display screen which can detect a finger swipe gesture.

### BACKGROUND

Many consumer device screens have swipe and pinch gesture features. People are so used to such features, that they make such gestures almost automatically, or as a matter of habit.

### SUMMARY

According to one aspect, a touch sensitive display screen system for performing a touch screen finger swipe operation includes a touch sensitive display having a screen edge along an outer screen perimeter. A processor is communicatively coupled to the touch sensitive display and operatively coupled to a memory. The processor runs a trigger on release button process stored on the memory. The touch sensitive display displays at least one trigger on release button defined by a button area disposed at about an edge of the touch sensitive display as an edge button. A finger swipe motion from a position on the touch sensitive display outside of the button area, to the edge button and continuing over the screen edge, causes an action to be performed by the processor based on an indication of a screen swipe event.

In one embodiment, the touch sensitive display includes a display of a controller device.

In another embodiment, the edge button is displayed adjacent to a right edge of the touch sensitive display or adjacent to a left edge of the touch sensitive display.

In yet another embodiment, the button area includes a visible display area on the touch sensitive display.

In yet another embodiment, the visible display area includes an icon or text indicative of a function of the edge button.

In yet another embodiment, the button area includes a display area not visible on the touch sensitive display.

In yet another embodiment, the touch sensitive display screen system includes a display screen of a controller device of a water heater.

In yet another embodiment, the at least one trigger on release button includes the edge button having a rectangular button area that runs along about an entire left edge or about an entire right edge outer screen perimeter of the touch sensitive display.

In yet another embodiment, the touch sensitive display screen system includes a plurality of edge buttons disposed along a left edge or a right edge or any combination thereof of the outer screen perimeter of the touch sensitive display.

According to another aspect, a method, includes, at a controller device with a touch screen display: placing an edge button, about adjacent to an outer edge of the touch screen display, the edge button including a trigger on release bottom type; indicating by a processor of a controller, a finger swipe which begins from anywhere on a touch screen other than a button area of the edge button, and which moves while in contact with a surface of the touch screen over the edge button and then off a screen edge, as a detection of the finger swipe; and causing the controller device to take an action based on the detection of the finger swipe.

In one embodiment, the step of placing the edge button includes placing a visible edge button.

In another embodiment, the step of placing the edge button includes placing an invisible edge button.

In yet another embodiment, the controller includes a controller of a water heater.

According to yet another aspect, a non-transitory computer-readable medium for processing a swipe gesture, the non-transitory computer-readable medium including instructions instruction which, when executed by a computer, cause the computer to: receive a detection of a swipe gesture via a touch screen, wherein the detection of the swipe gesture includes a finger swipe which begins from anywhere on the touch screen other than a button area of a touch screen trigger on release button as an edge button, and which moves while in contact with a surface of the touch screen over the edge button and then off a screen edge; and to provide an indication of a detected finger swipe to cause an action by the computer based on the indication of the detected finger swipe.

The foregoing and other aspects, features, and advantages of the application will become more apparent from the following description and from the claims.

### BRIEF DESCRIPTION OF THE DRAWINGS

The features of the application can be better understood with reference to the drawings described below, and the claims. The drawings are not necessarily to scale, emphasis instead generally being placed upon illustrating the principles described herein. In the drawings, like numerals are used to indicate like parts throughout the various views.

FIG. 1 is drawing showing the prior art use of a trigger on release screen button type;

FIG. 2 is a drawing showing a new use for the button type of FIG. 1 placed at an edge of a screen;

FIG. 3 is a block diagram showing an exemplary display and processor suitable to perform the new edge button swipe feature of the Application; and

FIG. 4 is flow chart showing the operation of an exemplary edge button swipe process.

### DETAILED DESCRIPTION

Many consumer device screens have swipe and pinch gesture features. Such computationally intensive screen systems locate, follow, and react to finger touch points and finger movement anywhere on a touch sensitive screen, such as a capacitive touch screen. One problem is that advanced features such as the swipe function are expensive to provide and support when using less powerful controllers. The new “edge buttons” of the Application mimic the screen swipe function while using only minimal controller (processor) resources.

Press events and release events: Buttons on an electronic display (computer monitor or touchscreen) can be triggered on multiple events including a button Press Event or a Release Event. When a button is programmed to trigger on a Release Event, the button is activated when the user lifts their finger when the finger is above the button. To cancel the user just needs to move their finger off the button while still pressing. This is done to give the user the opportunity to “cancel” their choice after that have pressed the button.

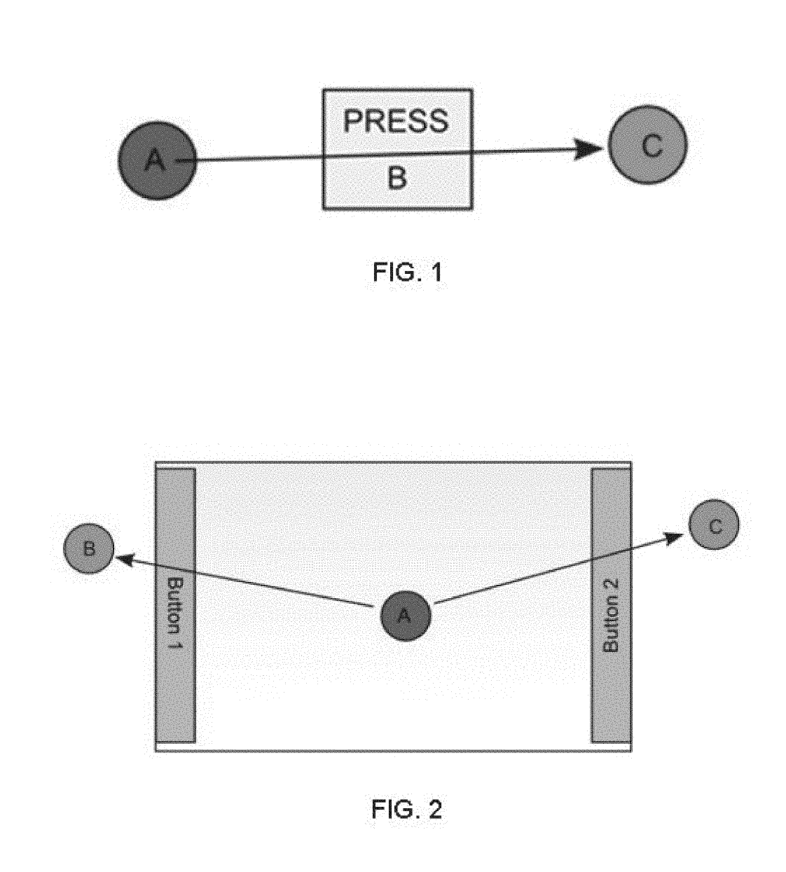

In FIG. 1, if a user presses at point A and releases at point B the gray “Press” button is triggered. If the user presses at point A releases at point C the button is not triggered.

Solution—Trigger on release edge buttons which mimic the screen swipe feature

Using this press event and release event functionality, the edge button forces the button to be released when the user is still on the button. It was realized that the position of the edge button at about a physical edge of the display, does not allow the user to lift their finger off the button in a way that can be detected by pixels of the touch sensitive display, when moving in a left-right motion (for a right side edge button) or right-left motion (for a left side edge button). There is no additional screen space for the user to lift their finger, so the finger lift appears to the processor, to occur when the finger is still over the button.

For example, in FIG. 2, by use of edge buttons, moving from A-to-B or from A-to-C triggers the left and right buttons respectively and thus mimics the swipe function on more expensive capacitive touchscreens on a relatively inexpensive display with two screen buttons. The button borders in FIG. 2 are for illustration only. In some embodiments, the buttons can be visible, while in other embodiments, the buttons, while present at a desired screen edge position, can be made not visible on the screen.

Detection of a swipe gesture, typically a finger swipe, of the prior art relies on detection and movement of the finger over many sensitive pixels. As the technology has advanced, swipe detection has grown to include velocity of movement, acceleration of movement, vector directions, both straight line and curved, and even a varying pressure applied to the screen as a function of time.

What is different is that in the new system and method according to the Application is that, a swipe gesture can be detected in effect with a single point of data. Because an edge button is at a physical edge of the touch sensitive display screen, direction is established merely by the location of the edge button itself. That is, the finger gesture must by definition begin at some point within the screen and move towards, and the over the edge button and over the edge of the display. Each edge button thus, establishes about the direction of the swipe from inside the screen (within the edge perimeter) to, and over the edge button. For example, an edge button located at the right edge of the display defines a left to right finger wipe direction of motion to cause a finger swipe detection. Moreover, within some limits of the timing of the trigger on release button type, which is either fixed, or in some embodiments can be set to any suitable time scales, there is no need to measure speed and/or rate of acceleration of the finger movement over the screen. There only needs to be a positive detection by the trigger on release button that a finger has been registered as “pushing” the button.

It can now be better understood that while the original intent of the new system and method according to the Application was to save processor overhead (processing cost) for relatively inexpensive controller touch screens (economic cost), the benefits of overall efficiency are considerable and can apply more widely to any suitable touch screen or touch sensitive surface, including any suitable multifunction device ranging from smart phones, video gaming to all types of commercial and industrial controllers.

On detection of a finger swipe gesture by a finger so passing over an edge button, the processor can take some action based on the detection of the finger swipe gesture associated with or assigned to that edge button. There can be any suitable number of edge buttons about adjacent to any outer physical edge of the touch display. Typically, the edge buttons will be aligned along a right side edge of the touch display to detect a swipe right direct motion, along the left edge of the touch display to detect a left swipe motion, or any combination thereof.

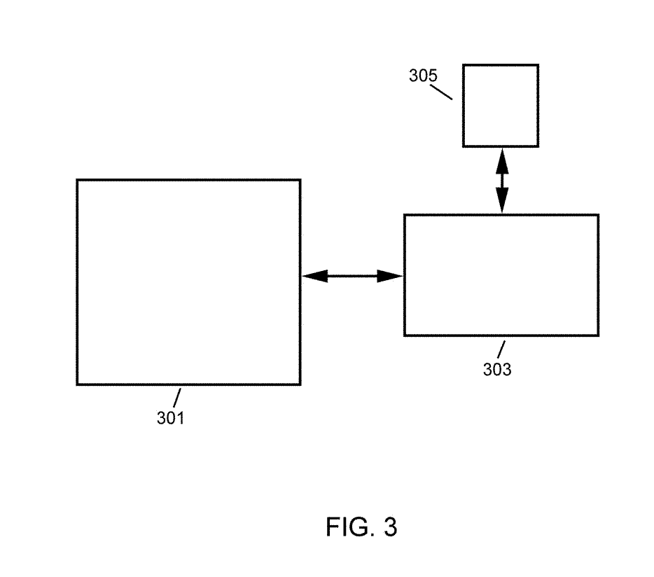

FIG. 3 is a block diagram showing an exemplary display and processor suitable to perform the new edge button swipe feature of the Application. A touch sensitive display screen system for performing a touch screen finger swipe operation includes a touch sensitive display 301 having a screen edge along an outer screen perimeter. A processor 303 is communicatively coupled to the touch sensitive display and operatively coupled to a memory 305. The memory, typically any suitable non-volatile memory, can be disposed within a common integrated package, such as, for example, a microcomputer chip, or be separate and operationally coupled to the processor. The process can be run directly from the memory (e.g. run directly from non-volatile memory as firmware), or read into another memory at time of execution (e.g. read from non-volatile memory into a RAM for execution).

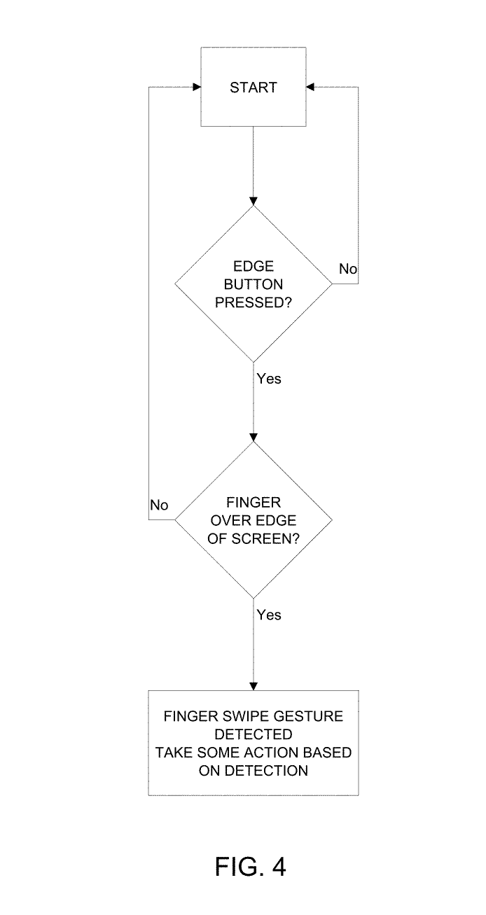

FIG. 4 is flow chart showing the operation of an edge button swipe process. Following the start of the process, the process registers if the edge button is pressed. If the edge button has been pressed, then either releasing finger pressure from the button area, or more specifically with respect to the advance of the Application, moving the finger past the edge button in the direction of the edge of the display and over the edge of the display, causes a registration of the finger swipe gesture (from anywhere inside the perimeter of the display, over the edge button, and past the physical edge of the touch sensitive display screen). Some action can then be taken based on the detection of the finger swipe gesture. The reason the new system and method works as described hereinabove, is because a trigger on release button is designed to cancel if the finger is detected elsewhere on the surface of the display outside of the button area when the finger is released. However, it was realized that an exception to the intended operation of the trigger on release button is that if the edge button is located adjacent to an outside perimeter of the physical display screen, then where the finger slides sideways in a direction off display, to the trigger on release button, it appears as if the finger was pressing the button when the finger pressure was released. Because the trigger on release button cancel works by detecting a finger pressure outside of the button area, when the finger leaves the edge of the display, there can be no off-screen pressure detection or indication which would cancel the trigger on release button press.

An action performed by a processor or controller can be any suitable action which can be programmatically controlled. For example, a right swipe gesture can cause another page to be displayed on a controller. The another page can further have edge buttons associated with other actions. One of those edge buttons can, for example, cause the processor or controller to display the last page. Other suitable actions include more hardware oriented actions. For example, an edge button can cause a calibration routine page to be displayed by a controller of a water heater. An edge button on the calibration page can cause a calibration routine to begin. Or, an edge button of water heater controller can cause a diagnostic mode to begin, a diagnostic page to show, or a certain set of measured parameters indicative of a state of the water heater at that time or at some time in the past where performance data was previously recorded. Or, and edge button can part of a controller set up page, where, for example, the presence of a certain electronics card is chosen as part of factory or field configuration routine. These exemplary actions are merely exemplary non-limiting illustrations of the any suitable actions which a processor or controller could take based on detection of finger swipe.

It is understood that an edge button as described hereinabove can be provided by running code on any suitable processor, typically a microcomputer embedded in the display, or a microcomputer which operates the display. Any suitable processor can be used, including any suitable logic devices, programmable arrays, etc. which can execute a computer code to show the edge buttons on the screen and provide the desired trigger on release operation. It is unimportant whether the processor is physically part of the display, or on a separate board or module which controls a touch sensitive display. The processor is typically operatively coupled to at least one memory device of any suitable memory device type. A computer as used herein includes any suitable processor operatively coupled to any suitable memory to perform a finger swipe gesture by a finger pass over an edge button of a trigger on release type button as described hereinabove.

Firmware or software to cause edge trigger on release buttons as described hereinabove can be provided on a computer readable non-transitory storage medium. A computer readable non-transitory storage medium as non-transitory data storage includes any data stored on any suitable media in a non-fleeting manner Such data storage includes any suitable computer readable non-transitory storage medium, including, but not limited to hard drives, non-volatile ROM or RAM, SSD devices, CDs, DVDs, etc.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A touch sensitive display screen system for performing a touch screen finger swipe operation comprising:
a touch sensitive display having a screen edge along an outer screen perimeter;
a processor communicatively coupled to said touch sensitive display and operatively coupled to a memory, said processor to run a trigger on release button process stored on said memory, the touch sensitive display displaying at least one trigger on release button defined by a button area disposed at about an edge of said touch sensitive display as an edge button; and
wherein a finger swipe motion from a position on the touch sensitive display outside of said button area, to said edge button and continuing over said screen edge, causes an action to be performed by said processor based on an indication of a screen swipe event.

2. The touch sensitive display screen system of claim 1, wherein said touch sensitive display comprises a display of a controller device.

3. The touch sensitive display screen system of claim 1, wherein said edge button is displayed adjacent to a right edge of said touch sensitive display or adjacent to a left edge of said touch sensitive display.

4. The touch sensitive display screen system of claim 1, wherein said button area comprises a visible display area on said touch sensitive display.

5. The touch sensitive display screen system of claim 4, wherein said visible display area includes an icon or text indicative of a function of said edge button.

6. The touch sensitive display screen system of claim 1, wherein said button area comprises a display area not visible on said touch sensitive display.

7. The touch sensitive display screen system of claim 1, wherein said touch sensitive display screen system comprises a display screen of a controller device of a water heater.

8. The touch sensitive display screen system of claim 1, wherein said at least one trigger on release button comprises said edge button having a rectangular button area that runs along about an entire left edge or about an entire right edge outer screen perimeter of said touch sensitive display.

9. The touch sensitive display screen system of claim 1, comprising a plurality of edge buttons disposed along a left edge or a right edge or any combination thereof of said outer screen perimeter of said touch sensitive display.

10. A method, comprising:
at a controller device with a touch screen display:
placing an edge button, about adjacent to an outer edge of said touch screen display, said edge button comprising a trigger on release bottom type;
indicating by a processor of a controller, a finger swipe which begins from anywhere on a touch screen other than a button area of said edge button, and which moves while in contact with a surface of said touch screen over said edge button and then off a screen edge, as a detection of said finger swipe; and
causing said controller device to take an action based on said detection of said finger swipe.

11. The method of claim 10, wherein said step of placing said edge button comprises placing a visible edge button.

12. The method of claim 10, wherein said step of placing said edge button comprises placing an invisible edge button.

13. The method of claim 10, wherein said controller comprises a controller of a water heater.

14. A non-transitory computer-readable medium for processing a swipe gesture, the non-transitory computer-readable medium comprising instructions instruction which, when executed by a computer, cause the computer to:
receive a detection of a swipe gesture via a touch screen, wherein the detection of the swipe gesture comprises a finger swipe which begins from anywhere on said touch screen other than a button area of a touch screen trigger on release button as an edge button, and which moves while in contact with a surface of said touch screen over said edge button and then off a screen edge; and
provide an indication of a detected finger swipe to cause an action by said computer based on said indication of said detected finger swipe.
